(19) United States
(12) Patent Application Publication
(10) Pub. No.: US 2025/0039476 A1
(43) Pub. Date: Jan. 30, 2025

(54) VIDEO ENHANCEMENT METHOD AND APPARATUS

(71) Applicant: Samsung Electronics Co., Ltd., Suwon-si (KR)

(72) Inventors: Youxin CHEN, Nanjing (CN); Longhai WU, Nanjing (CN); Jie CHEN, Nanjing (CN)

(21) Appl. No.: 18/916,139

(22) Filed: Oct. 15, 2024

Related U.S. Application Data
(63) Continuation of application No. PCT/KR2023/008488, filed on Jun. 20, 2023.

(30) Foreign Application Priority Data
Jul. 22, 2022 (CN) 202210871656.5

(51) Int. Cl. H04N 21/234; G06T 7/00; G06V 10/42; H04N 21/845

(52) U.S. Cl. CPC H04N 21/23424; G06T 7/0002; G06V 10/42; H04N 21/8456; G06T 2207/30168

(57) ABSTRACT

The present disclosure discloses a video enhancement method and apparatus. The method includes: segmenting a target video into a plurality of groups of images, the images in the same group belonging to the same scene; determining, for each group of images, a matched video enhancement algorithm using a pre-trained quality assessment model, and performing video enhancement processing on the each group of images using the video enhancement algorithm; and sequentially splicing video enhancement processing results of all groups of images to obtain video enhancement data of the target video. With the present disclosure, the video enhancement processing effect can be improved and the video viewing experience can be improved.

### CROSS-REFERENCE TO RELATED APPLICATIONS

This application is a continuation of International Application No. PCT/KR2023/008488 designating the United States, filed on Jun. 20, 2023, in the Korean Intellectual Property Receiving Office and claiming priority to Chinese Patent Application No. 202210871656.5, filed on Jul. 22, 2022, in the Chinese Patent Office, the disclosures of each of which are incorporated by reference herein in their entireties.

### BACKGROUND

### Field

The disclosure relates to video processing technologies, and more particularly, to a video enhancement method and apparatus.

### Description of Related Art

Currently, in order to improve video visual effects, video enhancement technologies are adopted for many videos to improve video quality.

Existing video enhancement schemes are prone to deformation of video pictures, artifact and other problems, and found the following reasons through research and analysis.

In the existing video enhancement schemes, a video enhancement parameter of a certain video enhancement algorithm is usually adjusted according to preset video picture content features, such as saliency features of video content, video coder information, histogram features, and contrast, so as to perform video enhancement processing on a target video. However, many scenes are usually involved in a real video, video content styles are often greatly different, and there are complex non-linear motion and illumination changes in consecutive frames. Since a single video enhancement algorithm is limited by limited preset features and lacks generalization in unknown videos, it cannot be ensured that the single video enhancement algorithm adapts to the enhancement of all video picture scenes. Thus, deformation of some video pictures, artifact and other situations may be caused, thereby reducing the video viewing experience.

### SUMMARY

Embodiments of the disclosure provide a video enhancement method and apparatus. The video enhancement processing effect can be improved and the video viewing experience can be improved.

According to an example embodiment, a video enhancement method includes: dividing (or segmenting) a target video into a plurality of groups of images, the images in the same group belonging to the same scene; determining, for each group of images, a matched video enhancement algorithm using a trained quality assessment model, and performing video enhancement processing on the each group of images using the video enhancement algorithm; and sequentially splicing video enhancement processing results of all groups of images to obtain video enhancement data of the target video.

According to an example embodiment, a video enhancement apparatus, comprises: a video segmentation unit, comprising circuitry, configured to segment a target video into a plurality of groups of images, the images in the same group belonging to the same scene; a video enhancement unit, comprising circuitry, configured to determine, for each group of images, a matched video enhancement algorithm using a trained quality assessment model, and perform video enhancement processing on the each group of images using the video enhancement algorithm; and a data splicing unit, comprising circuitry, configured to sequentially splice video enhancement processing results of all groups of images to obtain video enhancement data of the target video.

According to an example embodiment, a video enhancement device, comprises: at least one processor, comprising processing circuitry, and a memory.

The memory stores an application executable by at least one processor, individually and/or collectively, to cause the video enhancement device to perform video enhancement method as described above.

According to an example embodiment, a non-transitory computer-readable storage medium, having computer-readable instructions stored thereon for performing the video enhancement method when executed by at least one processor of a video enhancement device, individually and/or collectively, as described above is provided.

According to an example embodiment, a computer program product, including computer programs/instructions is provided. When executed by at least one processor of a video enhancement device, individually and/or collectively, implement the steps of the video enhancement method as described above.

According to a video enhancement scheme of various example embodiments of the disclosure, a target video is split by distinguishing scenes, matched video enhancement algorithms are determined for each group of the split images respectively, and then video enhancement processing is performed on each group of images using the matched video enhancement algorithms. In this way, by refining the video enhancement granularity, video enhancement is performed using a video enhancement algorithm matched with the video content of each group of images. The video enhancement effect can be improved, the picture defects of video enhancement can be reduced, and the video viewing experience can be improved. The video enhancement may be performed using one video enhancement algorithm for each group of images, so that the video memory overhead can be effectively reduced, and the video enhancement processing efficiency can be improved.

### BRIEF DESCRIPTION OF THE DRAWINGS

The above and other aspects, features and advantages of certain embodiments of the present disclosure will be more apparent from the following detailed description, takin in conjunction with the accompanying drawings, in which:

FIG. 1 is a flowchart illustrating an example method according to various embodiments;

FIG. 2 is a diagram illustrating an example configuration of a quality assessment model according to various embodiments;

FIG. 3 is a diagram illustrating an example of sample data construction for training the quality assessment model according to various embodiments;

FIG. 4 is a diagram illustrating an example applied to tasks of video super-resolution (VSR) and video frame interpolation (VFI) according to various embodiments;

FIG. 5 is a diagram illustrating an example of an effect applied to a frame interpolation algorithm of a video stream according to various embodiments;

FIG. 6 is a diagram illustrating an example of an effect applied to VSR according to various embodiments; and

FIG. 7 is a block diagram illustrating an example configuration of an apparatus according to various embodiments.

### DETAILED DESCRIPTION

Various example embodiments of the disclosure will be described in greater detail below with reference to the accompanying drawings.

Functions related to artificial intelligence (hereinafter referred to as AI) according to the disclosure may be operated through a processor and a memory. The processor may comprise one or more processors. In this case, the one more processors may be a general purpose processor such as a CPU, an AP, a digital signal processor (DSP), or the like, or, a graphics dedicated processor such as GPU, a vision processing unit (VPU), or an AI dedicated processor such as an NPU. One or more processors may control to process an input data according to a predefined operating rule or AI model stored in the memory. Alternatively, when one or more processors are an AI dedicated processor, the AI dedicated processor may be designed with a hardware structure specialized for processing a specific AI model. The processor may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The predefined operating rule or AI model is characterized by being made through learning. Being made through learning may refer, for example, to a basic AI model being trained using a plurality of learning data by a learning algorithm, thereby creating a predefined operation rule or AI model set to perform a desired feature (or purpose). Such learning may be made in a device itself in which AI according to the disclosure is performed, or may be made through a separate server and/or system. Examples of learning algorithms include supervised learning, unsupervised learning, semi-supervised learning, or reinforcement learning, but are not limited to the above examples.

The AI model may include a plurality of neural network layers. Each of the plurality of neural networks has a plurality of weight values, and performs neural network calculation through calculations between a calculation result of a previous layer and a plurality of weights. The plurality of weight values that the plurality of neural network layers have may be optimized by learning results of an AI model. For example, the plurality of weights may be updated to reduce or minimize a loss value or a cost value obtained from the AI model during the learning process. The AI neural networks may include, for example, a deep neural network (DNN), for example, a convolutional neural network (CNN), a recurrent neural network (RNN), a restricted boltzmann machine (RBM), deep belief network (DBN), bidirectional recurrent deep neural network (BRDNN), deep Q-networks, and the like, but are not limited to the above examples.

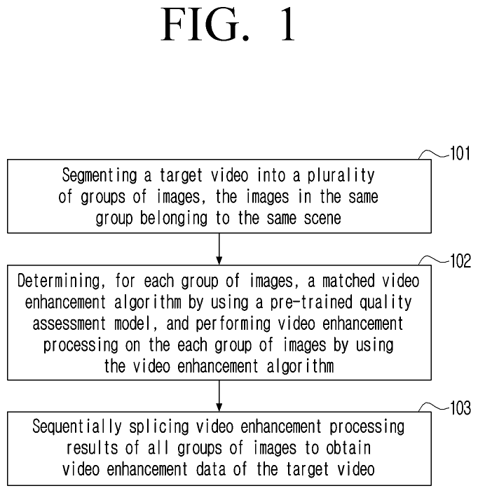

FIG. 1 is a flowchart illustrating an example video enhancement method according to various embodiments.

In step 101, a target video is segmented into a plurality of groups of images. The images in the same group belong to the same scene.

This step is used for dividing (or segmenting), by distinguishing scenes a target video to be subjected to video enhancement processing. For example, when dividing (or segmenting), it is necessary to ensure that images in the same group belong to the same scene, so as to respectively select a matched algorithm for processing according to video groups of different scenes in subsequent steps, thereby improving the video enhancement effect and reducing the video enhancement overhead.

In an embodiment, a target video may be specifically segmented into a plurality of groups of images by using the following method.

Scenes in the target video are identified using a scene boundary detection algorithm.

This step is used for identifying scene changes in a video using a scene boundary detection algorithm so as to identify various scenes in a target video. The identification may be achieved using existing scene boundary detection algorithms, and the detailed descriptions thereof may not be provided here.

For each of the scenes, video frames are extracted from a frame sequence corresponding to the each of scenes using a sliding window, and the video frames extracted each time are taken as a group of images.

k frames are extracted each time. k may refer, for example, to a preset number of frames of a group of images. If the number of frames remaining to be extracted in the each of scenes is less than k, a group of images may be obtained after supplementing to k frames using preset filling frames, so as to ensure that the number of frames of each group of images reaches k, thereby enabling each group of images to be input to the quality assessment model for normal processing.

Video frame extraction on a frame sequence of a scene using a sliding window may be implemented using the existing methods, and the detailed descriptions thereof may not be provided here.

In step 102, a matched video enhancement algorithm is determined for each group of images using a pre-trained quality assessment model, and video enhancement processing is performed on the each group of images using the video enhancement algorithm.

In this step, before performing video enhancement, a matched video enhancement algorithm is selected for the each group of images using a pre-trained quality assessment model, and video enhancement processing is performed using this algorithm. In this way, video enhancement processing using the matched algorithm can effectively improve the quality of video enhancement, reduce the picture defects of video enhancement and improve the video viewing experience; since only one algorithm may be used for video enhancement processing on each group of images, efficiency of the video enhancement processing is high, and the computation overhead is low.

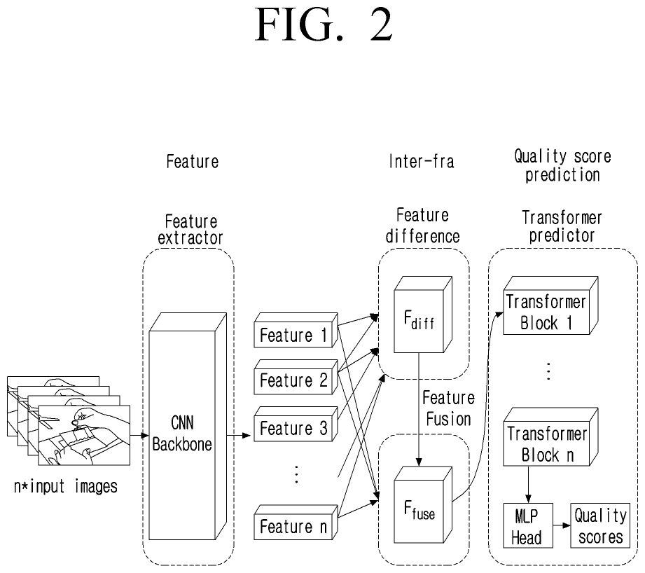

FIG. 2 is a diagram illustrating an example configuration of a quality assessment model, including four parts: a feature extractor, a feature difference, a feature fusion, and a transformer predictor. As shown in FIG. 2, the model extracts features of each frame through a CNN backbone and estimates an inter-frame difference between the features of adjacent frames. Inter-frame difference features and image features are fused to compensate for background illumination and other information. Finally, the fused features are sent to a plurality of consecutive transformer blocks to extract global features and enhance feature regions which are more sensitive to video enhancement. The first vector output by the last transformer block will predict quality scores of different enhancement algorithm processing results through a multilayer perceptron (MLP) head. A higher score indicates a stronger algorithm.

In an embodiment, as shown in FIG. 2, a matched video enhancement algorithm may be determined for each group of images using a pre-trained quality assessment model through the following steps.

The quality assessment model extracts image features from a currently input group of images using a deep residual network.

For example, feature extraction may be performed using a ResNet50 network. In order to reduce the calculation complexity of a model, an output result of the third resent block may be an extracted image feature.

Inter-frame difference information is generated based on the image features output by the deep residual network.

Considering that motion information is important in video tasks, inter-frame difference information may be obtained by subtracting consecutive frames in this step for subsequent processing. Methods for generating inter-frame difference information is known to those skilled in the art, and the detailed descriptions thereof may not be provided here.

Channel fusion processing is performed on the inter-frame difference information and the image features.

Considering that a better result cannot be achieved by relying only on the difference information, the difference information and the image features are fused over channels, so as to compensate for the missing background information, illumination information, etc., thereby improving the picture quality of images. The specific implementation of this step is known to those skilled in the art, and the detailed descriptions thereof may not be provided here.

Global features are extracted based on the result of channel fusion processing.

In this step, global features are extracted using a transformer block. When the quality assessment model is pre-trained, regions sensitive to an enhancement algorithm may also be positioned using the transformer block, so as to provide a user reference video enhancement effect.

A quality score of each algorithm in a preset set of video enhancement algorithms for performing video enhancement processing on the currently input group of images is predicted using the MLP head based on the global features.

This step is used for predicting quality scores of processing results of different enhancement algorithms on a current group of images. The specific implementation of this step is known to those skilled in the art, and the detailed descriptions thereof may not be provided here.

An algorithm is selected from the preset set of video enhancement algorithms as a video enhancement algorithm matched with the currently input group of images according to a strategy of preferentially selecting a high-score algorithm based on the quality score.

This step is used for selecting a video enhancement algorithm matched with a current image group so as to improve the video enhancement effect.

In an embodiment, an algorithm may be specifically selected from the preset set of video enhancement algorithms as a video enhancement algorithm matched with the currently input group of images using the following method.

It is determined whether a maximum value of the quality score is less than a preset minimum quality threshold. If yes, a preset standby video enhancement algorithm is taken as a video enhancement algorithm matched with the currently input group of images. Otherwise, a video enhancement algorithm corresponding to the maximum value is taken as a video enhancement algorithm matched with the currently input group of images.

To avoid the limitations of the existing enhancement methods, a comparison is made whether the highest score exceeds a preset minimum quality threshold. If the highest score is less than the minimum quality threshold, a preset alternative video enhancement algorithm is selected. Otherwise, a video enhancement algorithm with the highest score is directly used.

The standby video enhancement algorithm may refer, for example, to a video enhancement algorithm used when all the algorithms in the set of video enhancement algorithms are not suitable for performing video enhancement processing on a certain group of images.

The minimum quality threshold may be used for enabling a better video enhancement effect to be obtained based on the selected video enhancement algorithm, thereby avoiding the reduction of the video enhancement effect by the mismatched video enhancement algorithm. An appropriate value may be specifically set according to actual picture quality requirements.

Table 1 below illustrates an example of the above model selection method. In this example, the set of video enhancement algorithms includes {RIFE, SepConv, DAIN}, and the minimum quality threshold is 1. As shown in the first and second rows of the table, when the highest score is not less than the minimum quality threshold of 1, the algorithm corresponding to the highest score is selected. As shown in the third row of the table, when the highest score is 0.5, the standby video enhancement algorithm is selected at this moment since the highest score is less than the minimum quality threshold of 1.

TABLE 1

| RIFE | SepConv | DAIN | |
|---|---|---|---|
| (Index | (Index | (Index | Index of selected |
| Number = 0) | Number = 1) | Number = 2) | algorithm |
| 2.2 | 1 | 2.4 | 2 |
| 3.2 | 2.1 | 0.9 | 0 |
| 0.1 | 0.3 | 0.5 | Standby video |
| | | | enhancement |
| | | | algorithm |

In an embodiment, the quality assessment model may be specifically pre-trained using the following method.

The quality assessment model is pre-trained using preset sample data.

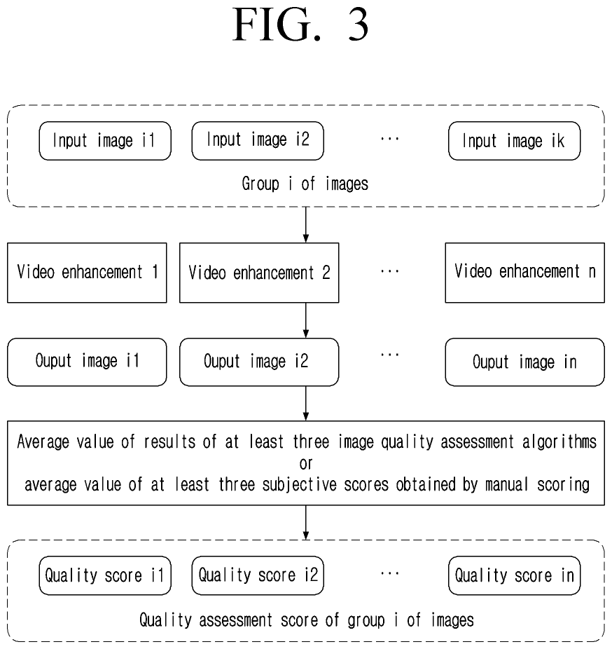

As shown in FIG. 3, sample data may be specifically constructed using the following method.

For each group of sample images, video enhancement processing is performed on the each group of sample images using each algorithm in a preset set of video enhancement algorithms respectively. A quality score of a video enhancement processing result of each of the video enhancement algorithms is assessed using a preset image quality assessment algorithm or a manual scoring mode, and an average value of the quality scores of the video enhancement algorithms is set as a quality score label of the each group of sample images in the corresponding algorithms.

In an embodiment, to improve the accuracy of sample labels, at least three image quality assessment algorithms may be used for assessment or manual scoring is implemented by at least three scorers. For example, the number of the image quality assessment algorithms is greater than 2, and the number of people participating in the manual scoring is greater than 2.

Referring back to FIG. 1, in step 103, video enhancement processing results of all groups of images are sequentially spliced to obtain video enhancement data of the target video.

In this step, video enhancement processing results of all groups of images obtained in step 102 are sequentially concatenated to obtain video enhancement data of the target video.

As can be seen from the above method, according to various example embodiments, a video is segmented, the adaptability of different enhancement algorithms to a certain group of images is accurately predicted based on image content and algorithm characteristics, and the most reasonable algorithm is intelligently selected. The picture defects of video enhancement results can be reduced, the uncertainty of random model selection can be avoided, and the visual quality can be improved.

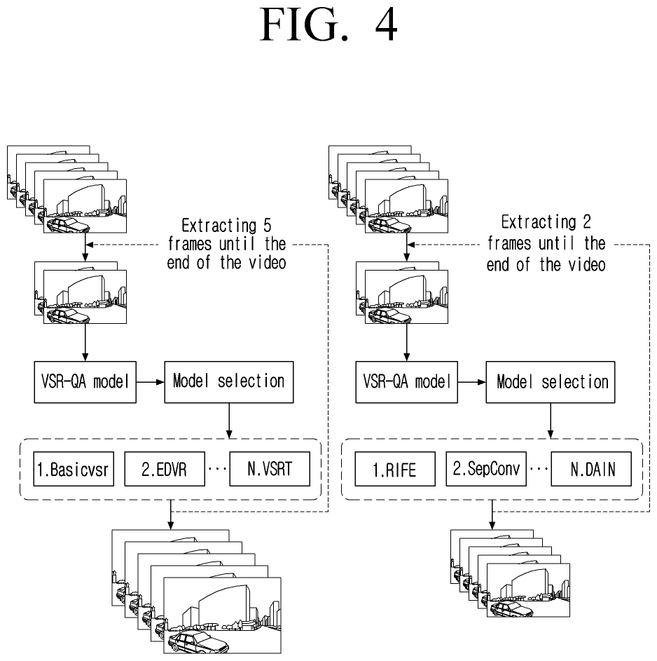

In practical applications, the above technical solution may be applied to the implementation of various machine vision tasks. FIG. 4 is a diagram illustrating an example applied to tasks of VSR and VFI according to various embodiments. As shown in FIG. 4, corresponding quality assessment models (QA models) and video enhancement algorithms may be trained for different tasks.

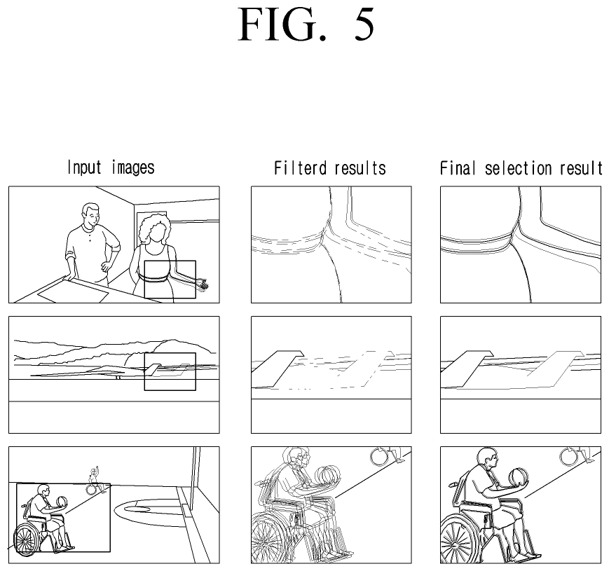

The above may be applied to a frame interpolation algorithm and can effectively improve the quality of an output video. FIG. 5 is a diagram of an effect example applied to a frame interpolation algorithm of a video stream according to various embodiments. As shown in FIG. 5, there is a significant blur effect in a processing result of a filtered video enhancement algorithm, and a processing result of a finally selected video enhancement algorithm is clearer.

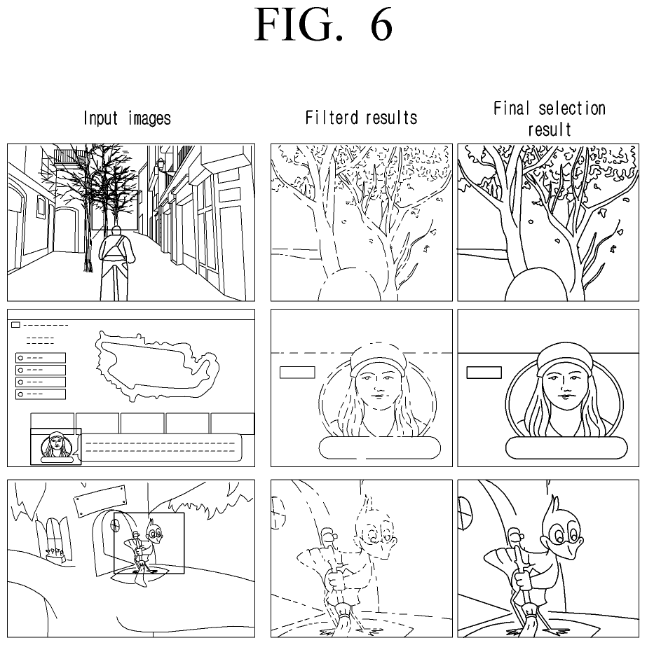

When the above is applied to an intelligent selection process of a super-resolution algorithm of a video stream, different super-resolution algorithms are selected according to different content features in a time domain. For example, a super-resolution algorithm with a smooth effect is selected for a background picture with simple lines, and a super-resolution algorithm that tend to enhance details is selected for content with rich content and complex texture, so as to improve the visual experience of video super-resolution. FIG. 6 is a diagram illustrating an example of an effect example applied to VSR according to various embodiments. As shown in FIG. 6, result images (trees or faces) with severe artifacts will be filtered while clear and smooth images will be selected.

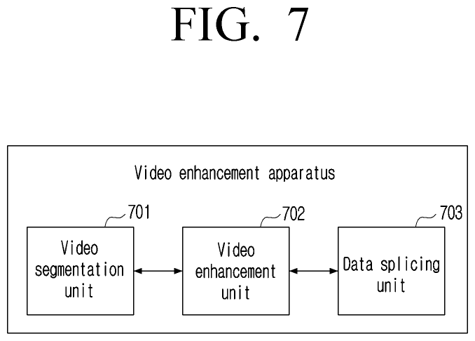

Embodiments of the disclosure provide a video enhancement apparatus based on the above. As shown in FIG. 7, the apparatus includes:
a video segmentation unit (e.g., including various processing circuitry and/or executable program instructions) 701, configured to segment a target video into a plurality of groups of images, the images in the same group belonging to the same scene;
a video enhancement unit (e.g., including various processing circuitry and/or executable program instructions) 702, configured to determine, for each group of images, a matched video enhancement algorithm using a pre-trained quality assessment model, and perform video enhancement processing on the each group of images using the video enhancement algorithm; and
a data splicing unit (e.g., including various processing circuitry and/or executable program instructions (703, configured to sequentially splice video enhancement processing results of all groups of images to obtain video enhancement data of the target video.

It should be noted that the above method and apparatus are based on the same concept. Since the principles of the method and apparatus for addressing the problems are similar, the implementations of the apparatus and the method may be referred to each other, and the repeated descriptions may not be provided.

Embodiments of the disclosure provide a video enhancement device based on the above. The device includes at least one processor, comprising processing circuitry, and a memory. The memory stores an application executable by at least one processor, individually and/or collectively, and at least one processor, individually and/or collectively is configured to cause the processor to perform the video enhancement method as described above. For example, a system or apparatus with a storage medium may be provided. A software program code that realizes the functions of any one implementation in the above embodiments is stored on the storage medium, and a computer (or CPU or MPU) of the system or apparatus is caused to read out and execute the program code stored in the storage medium. Furthermore, some or all of actual operations may be performed by means of an operating system or the like operating on the computer through instructions based on the program code. The program code read out from the storage medium may also be written into a memory provided in an expansion board inserted into the computer or into a memory provided in an expansion unit connected to the computer. An instruction based on the program code causes a CPU or the like installed on the expansion board or the expansion unit to perform some or all of the actual operations, thereby realizing the functions of any one of the above video enhancement method implementations.

The memory may be implemented as various storage media such as an electrically erasable programmable read-only memory (EEPROM), a flash memory, a programmable program read-only memory (PROM), etc. The processor may be implemented to include one or more central processing units or one or more field programmable gate arrays. The field programmable gate arrays are integrated with one or more central processing unit cores. Specifically, the central processing unit or central processing unit core may be implemented as a CPU or an MCU.

Embodiments of the disclosure may implement a computer program product, including computer programs/instructions. When executed by a processor, the computer programs/instructions implement the steps of the video enhancement method as described above.

It should be noted that not all the steps and modules in the above flowcharts and structure diagrams are necessary, and some steps or modules may be omitted according to actual requirements. The order of execution of the various steps is not fixed and may be adjusted as required. The division of the various modules is merely to facilitate the description of the functional division adopted. In actual implementation, one module may be implemented by being divided into a plurality of modules. The functions of the plurality of modules may also be realized by the same module. These modules may be located in the same device or in different devices.

Hardware modules in the various implementations may be implemented mechanically or electronically. For example, a hardware module may include a specially designed permanent circuit or logic device (e.g. a dedicated processor such as an FPGA or an ASIC) to perform a particular operation. The hardware module may also include a programmable logic device or circuit (e.g. including a general purpose processor or other programmable processors) temporarily configured by software to perform a particular operation. The implementation of the hardware modules mechanically, or using a dedicated permanent circuit, or using a temporarily configured circuit (e.g. configured by software) may be determined based on cost and time considerations.

As used herein, “schematic” may refer, for example, to “serving as an instance, example, or illustration”. Any illustration and implementation described herein as “schematic” should not be construed as a more preferred or advantageous solution. For simplicity of the drawings, those portions related to the present disclosure are schematically depicted in the figures and are not representative of an actual structure of a product. In addition, for simplicity and ease of understanding, only one of components having the same structure or function is schematically drawn or marked in some figures. As used herein, “one” does not limit the number of portions related to the present disclosure to “only one”, and “one” does not exclude the case that the number of portions related to the present disclosure is “more than one”. As used herein, “upper”, “lower”, “front”, “back”, “left”, “right”, “inner”, “outer”, and the like are used merely to indicate relative positional relationships between related portions, and do not limit absolute positions of these related portions.

The above description is merely of various example embodiments of the disclosure and is not intended to limit the protection scope of the present disclosure. Any modifications, equivalent replacements, improvements, etc. that come within the spirit and principles of the present disclosure are intended to be within the protection scope of the present disclosure, including the appended claims and their equivalents.

According to various embodiments, a video enhancement method may include dividing (or segmenting) a target video into a plurality of groups of images, the images in the same group belonging to the same scene, determining, for each group of images, a matched video enhancement algorithm using a pre-trained model, performing video enhancement processing on the each group of images using the video enhancement algorithm, and sequentially splicing video enhancement processing results of all groups of images to obtain video enhancement data of the target video.

The method may include obtaining the video enhancement data of the target video by splicing the video enhancement processing results of all groups of images.

The splicing may be described as “classifying” or “dividing”.

The pre-trained model may be described as “pre-trained AI (artificial intelligence) model”.

The determining, for each group of images, the matched video enhancement algorithm may include extracting, by the model, image features from a currently input group of images using a deep residual network, generating inter-frame difference information based on the image features output by the deep residual network, performing channel fusion processing on the inter-frame difference information and the image features, extracting global features based on a result of the channel fusion processing, and determining the matched video enhancement algorithm based on a quality score corresponding the global features.

The determining, for each group of images, the matched video enhancement algorithm may include predicting the quality score of each algorithm in a preset set of video enhancement algorithms for performing video enhancement processing on the currently input group of images, based on the global features, and selecting an algorithm from the preset set of video enhancement algorithms as a video enhancement algorithm matched with the currently input group of images according to a strategy of preferentially selecting a high-score algorithm based on the quality score.

The predicting the quality score of each algorithm may include predicting, by a multilayer perceptron (MLP) based on the global features, the quality score of each algorithm.

The selecting the algorithm may include determining whether a maximum value of the quality score is less than a preset minimum quality threshold, and selecting the algorithm based on a result of the determining operation.

The selecting the algorithm may include based on the maximum value of the quality score being less than the preset minimum quality threshold, taking a preset standby video enhancement algorithm as the video enhancement algorithm matched with the currently input group of images.

The selecting the algorithm may include based on the maximum value of the quality score being greater than or equal the preset minimum quality threshold, taking a video enhancement algorithm corresponding to the maximum value as the video enhancement algorithm matched with the currently input group of images.

The dividing a target video into a plurality of groups of images may include identifying scenes in the target video using a scene boundary detection algorithm, and extracting, for each of the scenes, video frames from a frame sequence corresponding to the each of the scenes using a sliding window, and taking the video frames extracted each time as a group of images, wherein k frames are extracted each time, k is a preset number of frames of a group of images, and if a number of frames remaining to be extracted in a scene is less than k, a group of images is obtained after supplementing to k frames.

The method may include pre-training the model using preset sample data, wherein a method for constructing the sample data may include performing, for each group of sample images, video enhancement processing on the each group of sample images using each algorithm in a preset set of video enhancement algorithms respectively, and assessing a quality score of a video enhancement processing result of each of the video enhancement algorithms using a preset image quality assessment algorithm or a manual scoring mode, and setting an average value of the quality scores of the video enhancement algorithms as a quality score label of the each group of sample images in corresponding algorithms.

A number of the image quality assessment algorithms is greater than 2, and a number of people participating in the manual scoring is greater than 2.

According to various example embodiments, the video enhancement apparatus may include memory and at least one processor, comprising processing circuitry. At least one processor, individually and/or collectively, may be configured to divide a target video into a plurality of groups of images, the images in the same group belonging to the same scene, determine, for each group of images, a matched video enhancement algorithm using a pre-trained model, perform video enhancement processing on the each group of images using the video enhancement algorithm, and sequentially splice video enhancement processing results of all groups of images to obtain video enhancement data of the target video.

At least one processor, individually and/or collectively, may be configured to extract, by the model, image features from a currently input group of images using a deep residual network, generate inter-frame difference information based on the image features output by the deep residual network, perform channel fusion processing on the inter-frame difference information and the image features, extract global features based on a result of the channel fusion processing, and determine the matched video enhancement algorithm based on a quality score corresponding the global features.

At least one processor, individually and/or collectively, may be configured to predict the quality score of each algorithm in a preset set of video enhancement algorithms for performing video enhancement processing on the currently input group of images, based on the global features, and select an algorithm from the preset set of video enhancement algorithms as a video enhancement algorithm matched with the currently input group of images according to a strategy of preferentially selecting a high-score algorithm based on the quality score.

At least one processor, individually and/or collectively, may be configured to predict, by a multilayer perceptron (MLP) based on the global features, the quality score of each algorithm.

At least one processor, individually and/or collectively, may be configured to determine whether a maximum value of the quality score is less than a specified minimum quality threshold, and select the algorithm based on a result of the determining operation.

At least one processor, individually and/or collectively, may be configured to, based on the maximum value of the quality score being less than the specified minimum quality threshold, taking a specified standby video enhancement algorithm as the video enhancement algorithm matched with the currently input group of images.

At least one processor, individually and/or collectively, may be configured to, based on the maximum value of the quality score being greater than or equal the specified minimum quality threshold, taking a video enhancement algorithm corresponding to the maximum value as the video enhancement algorithm matched with the currently input group of images.

At least one processor, individually and/or collectively, may be configured to identify scenes in the target video using a scene boundary detection algorithm, and extract, for each of the scenes, video frames from a frame sequence corresponding to the each of the scenes using a sliding window, and taking the video frames extracted each time as a group of images, wherein k frames are extracted each time, k is a specified number of frames of a group of images, and if a number of frames remaining to be extracted in a scene is less than k, a group of images is obtained after supplementing to k frames.

At least one processor, individually and/or collectively, may be configured to pre-train the model using preset sample data and perform, for each group of sample images, video enhancement processing on the each group of sample images using each algorithm in a preset set of video enhancement algorithms respectively, and assessing a quality score of a video enhancement processing result of each of the video enhancement algorithms using a preset image quality assessment algorithm or a manual scoring mode, and setting an average value of the quality scores of the video enhancement algorithms as a quality score label of the each group of sample images in corresponding algorithms.

A number of the image quality assessment algorithms is greater than 2, and a number of people participating in the manual scoring is greater than 2.

According to various embodiments, a video enhancement device, comprising at least one processor, comprising processing circuitry, and a memory, wherein the memory stores an application executable by at least one processor, individually and/or collectively for causing the video enhancement device to perform the video enhancement method according to the above description.

According to various example embodiments, a non-transitory computer-readable storage medium, having computer-readable instructions stored therein for performing the video enhancement method according to above description.

According to various example embodiments, a computer program product, comprising computer programs/instructions, wherein when executed by at least one processor, individually and/or collectively, the computer programs/instructions implement the steps of the video enhancement method according to the above description.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. A video enhancement method, comprising:
dividing a target video into a plurality of groups of images, the images in a same group belonging to a same scene;
determining, for each group of images, a matched video enhancement algorithm using a pre-trained model;
performing video enhancement processing on the each group of images using the video enhancement algorithm; and
sequentially splicing video enhancement processing results of all groups of images to obtain video enhancement data of the target video.

2. The method according to claim 1, wherein the determining, for each group of images, the matched video enhancement algorithm comprises:
extracting, by the model, image features from a currently input group of images using a deep residual network,
generating inter-frame difference information based on the image features output by the deep residual network,
performing channel fusion processing on the inter-frame difference information and the image features,
extracting global features based on a result of the channel fusion processing, and
determining the matched video enhancement algorithm based on a quality score corresponding the global features.

3. The method according to claim 2, wherein the determining, for each group of images, the matched video enhancement algorithm comprises:
predicting the quality score of each algorithm in a specified set of video enhancement algorithms for performing video enhancement processing on the currently input group of images, based on the global features, and
selecting an algorithm from the specified set of video enhancement algorithms as a video enhancement algorithm matched with the currently input group of images according to a strategy of preferentially selecting a high-score algorithm based on the quality score.

4. The method according to claim 3, wherein the predicting the quality score of each algorithm comprises:
predicting, by a multilayer perceptron (MLP) based on the global features, the quality score of each algorithm.

5. The method according to claim 3, wherein the selecting the algorithm comprises:
determining whether a maximum value of the quality score is less than a specified minimum quality threshold, and
selecting the algorithm based on a result of the determining operation.

6. The method according to claim 5, wherein the selecting the algorithm comprises:
based on the maximum value of the quality score being less than the specified minimum quality threshold, taking a specified standby video enhancement algorithm as the video enhancement algorithm matched with the currently input group of images.

7. The method according to claim 5, wherein the selecting the algorithm comprises:
based on the maximum value of the quality score being greater than or equal the specified minimum quality threshold, taking a video enhancement algorithm corresponding to the maximum value as the video enhancement algorithm matched with the currently input group of images.

8. The method according to claim 1, wherein the dividing a target video into a plurality of groups of images comprises:
identifying scenes in the target video using a scene boundary detection algorithm; and
extracting, for each of the scenes, video frames from a frame sequence corresponding to the each of the scenes using a sliding window, and taking the video frames extracted each time as a group of images, wherein k frames are extracted each time, k is a specified number of frames of a group of images, and based on a number of frames remaining to be extracted in a scene being less than k, a group of images is obtained after supplementing to k frames.

9. The method according to claim 1, further comprising:
pre-training the model using specified sample data, wherein a method for constructing the sample data comprises:
performing, for each group of sample images, video enhancement processing on the each group of sample images using each algorithm in a specified set of video enhancement algorithms respectively; and assessing a quality score of a video enhancement processing result of each of the video enhancement algorithms using a specified image quality assessment algorithm or a manual scoring mode, and setting an average value of the quality scores of the video enhancement algorithms as a quality score label of the each group of sample images in corresponding algorithms.

10. The method according to claim 9, wherein a number of the image quality assessment algorithms is greater than 2, and a number of people participating in the manual scoring is greater than 2.

11. A video enhancement apparatus, comprising:
memory; and
at least one processor, comprising processing circuitry;
wherein at least one processor, individually and/or collectively, is configured to:
divide a target video into a plurality of groups of images, the images in a same group belonging to a same scene,
determine, for each group of images, a matched video enhancement algorithm using a pre-trained model,
perform video enhancement processing on each group of images using the video enhancement algorithm, and
sequentially splice video enhancement processing results of all groups of images to obtain video enhancement data of the target video.

12. The method according to claim 11, wherein at least one processor, individually and/or collectively, is configured to:
extract, by the model, image features from a currently input group of images using a deep residual network,
generate inter-frame difference information based on the image features output by the deep residual network,
perform channel fusion processing on the inter-frame difference information and the image features,
extract global features based on a result of the channel fusion processing, and
determine the matched video enhancement algorithm based on a quality score corresponding the global features.

13. The method according to claim 12, wherein at least one processor, individually and/or collectively, is configured to:
predict the quality score of each algorithm in a specified set of video enhancement algorithms for performing video enhancement processing on the currently input group of images, based on the global features, and
select an algorithm from the specified set of video enhancement algorithms as a video enhancement algorithm matched with the currently input group of images according to a strategy of preferentially selecting a high-score algorithm based on the quality score.

14. The method according to claim 13, wherein at least one processor, individually and/or collectively, is configured to:
predict, by a multilayer perceptron (MLP) based on the global features, the quality score of each algorithm.

15. The method according to claim 13, wherein at least one processor, individually and/or collectively, is configured to:
determine whether a maximum value of the quality score is less than a specified minimum quality threshold, and
select the algorithm based on a result of the determining operation.
